(19) United States
(12) Patent Application Publication
(10) Pub. No.: US 2006/0195782 A1
(43) Pub. Date: Aug. 31, 2006

(54) Method and system for classifying and displaying tables of information

(75) Inventors: Chong Wang, Beijing (CN); Wei-Ying Ma, Beijing (CN); Xing Xie, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/068,721

(22) Filed: Feb. 28, 2005

(51) Int. Cl. G06F 17/00

(52) U.S. Cl. 715/509

(57) ABSTRACT

A table system includes a classification system and a display system. The classification system trains a classifier to classify tables of display pages as a data table or not a data table based on certain features of the tables. The display system identifies the tables of a display page, identifies the features of the tables, and then uses the classifier to classify the tables based on their features. When a table is not classified as a data table, the display system may display the table in a conventional one-column view. When a table is classified as a data table, the display system displays the data table in an alternate view that attempts to preserve the layout and thus meaning of the data table.

### TECHNICAL FIELD

The described technology relates generally to displaying of tables on a small display area.

### BACKGROUND

It can be particularly challenging to view images on small devices such as cell phones, mobile computers, and personal digital assistants (“PDAs”). These devices typically have a very small display area in which to display a display page. To display the display page, the devices may use software and information that is designed for devices with much larger display areas. For example, these devices may use a web browser to display standard size web pages. If a display page in a high resolution is displayed in such a small display area, the display page may need to be displayed in a much lower resolution to fit the entire display page. With such a low resolution, however, the user may not be able to see the details of the display page. Alternatively, if the display page is displayed in full resolution in a small display area, only a small portion of the display page can be displayed at once. To view other portions of the display page, the user needs to navigate (e.g., scroll and zoom) to view those portions. Because such devices are typically very small, it can be difficult for a user to perform such navigation.

Currently, most browsers used by small devices offer only a simplified set of user interface features that are directly ported from a desktop browser. Few designers of browsers, however, take the characteristics of a small device into consideration when designing their user interfaces. Small devices are different from larger devices in input capabilities, processing power, and screen characteristics. For example, since small devices usually do not have a keyboard or mouse, it can be difficult to navigate around a display page. The primary difference from a user's perspective is display area size. Because the display area is small, a user is forced to scroll and zoom in to areas of interest. Such scrolling and zooming are typically not necessary on a device with a large display area.

To allow for the effective display of web pages on a small display area, some techniques have been developed to dynamically adapt web pages that are too large for a small display area. One such adaptation technique is “page splitting,” which attempts to divide a web page into blocks that can fit as a unit into a small display area. One such page splitting technique analyzes the position and shape of HTML elements of a web page to identify blocks. However, it can be difficult to identify blocks from low-level HTML tags in a way that preserves page structure and does not lose information.

When a page is split, the device may display the blocks of the page in a single column on the display. Such display of the page is referred to as a “one-column view.” A one-column view effectively discards the layout of a block when it is wider than the display area. The discarding of the layout presents problems when the information of the block is correlated based on the layout. FIGS. 1A and 1B illustrate a table in a conventional view and a one-column view when the layout of the table is needed to fully understand the data. Such tables are typically defined using the <table> tag of HTML. Because a one-column view discards the layout of a table, the table of FIG. 1A may be displayed as the table of FIG. 1B. It is clear from FIG. 1A that the value 26.470 is the price of the stock with the symbol INTC. It is not clear, however, from FIG. 1B what is the meaning of the value 26.470.

The tables of an HTML document can be identified in a relatively straightforward manner. As such, a browser could take steps to display such tables in a way that may maintain some of their structure. Unfortunately, tables of an HTML document are used to lay out a page or block in such a way that the data of the page or block is not correlated to its structure. For example, an HTML document may use a <table> tag to define the overall layout of a page. The table may define two columns and five rows with cells of varying sizes in which unrelated data is presented. FIGS. 2A and 2B illustrate the layout of a page in a conventional view and a one-column view when the layout is not needed to fully understand the page. The data of the three cells of FIGS. 2A and 2B is independent of the data of other cells. Tables that primarily control a layout are referred to as “layout tables,” and tables that primarily specify relationships between its data are referred to as “data tables.” FIG. 3 illustrates the layout of a page in which the cells do have a relationship but the relationship is not strict. In this example, the meaning of the data of the cells can still be understood when displayed in a one-column view. Thus, such a table may be considered a layout table.

It would be desirable to have a technique that could easily identify a table as a data table or layout table. In addition, it would be desirable to have a technique for displaying data tables in a way that would preserve the relationships and meaning between the data of the data table when displayed on a small display.

### SUMMARY

A method and system for classifying and displaying tables for small display areas is provided. A table system includes a classification system and a display system. The classification system trains a classifier to classify tables of display pages as a data table or not a data table based on certain features of the tables. The display system uses the classifier when displaying a display page. The display system identifies the tables of a display page, identifies the features of the table, and then uses the classifier to classify the table based on its features. When a table is not classified as a data table, the display system may display the table in a conventional one-column view. When a table is classified as a data table, the display system displays the data table in an alternate view that attempts to preserve the layout and thus meaning of the data table.

### BRIEF DESCRIPTION OF THE DRAWINGS

FIGS. 1A and 1B illustrate a table in a conventional view and a one-column view when the layout of the table is needed to fully understand the data.

FIGS. 2A and 2B illustrate the layout of a page in a conventional view and a one-column view when the layout is not needed to fully understand the page.

FIG. 3 illustrates the layout of a page in which the cells do have a relationship but the relationship is not strict.

FIGS. 4A-4B and 5A-5B illustrate a one-column view and an alternate view of tables in one embodiment.

FIG. 6 is a block diagram that illustrates the transpose of a data table in one embodiment.

FIG. 7 is a block diagram that illustrates components of the table system in one embodiment.

FIG. 8 is a flow diagram that illustrates the processing of the train classifier component in one embodiment.

FIG. 9 is a flow diagram that illustrates the processing of the display element component in one embodiment.

FIG. 10 is a flow diagram that illustrates the processing of the display data table component in one embodiment.

FIG. 11 is a flow diagram that illustrates the processing of the transpose data table component in one embodiment.

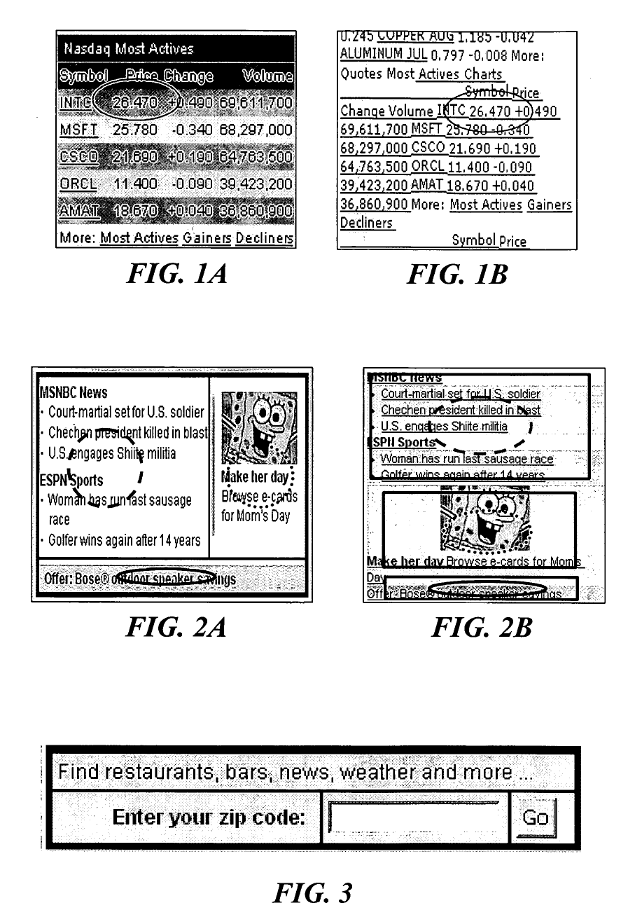

### DETAILED DESCRIPTION

A method and system for classifying and displaying tables for small display areas is provided. In one embodiment, a table system includes a classification system and a display system. The classification system trains a classifier to classify tables of display pages as a data table or not a data table (e.g., a layout table) based on certain features of the tables. The display system uses the classifier when displaying a display page. The display system identifies the tables of a display page, identifies the features of the table, and then uses the classifier to classify the table as a data table or a layout table based on its features. When a table is classified as a layout table, the display system may display the layout table in a conventional one-column view. When a table is classified as a data table, the display system displays the data table in an alternate view that attempts to preserve the layout and thus meaning of the data table. For example, the display system may display a data table in its original layout with scrollbars to allow a user to view only a portion of the data table at a time. Alternately, the display system may display a data table by zooming out so that the entire data table can be displayed in one column. As another example, the display system may attempt to transpose (or rotate) the data table (i.e., switching rows and columns) and display the transposed table if the width of the transposed table is narrower than the un-transposed table. If the un-transposed table would fit on the display device, then no alternate view would be needed. In this way, the display system can identify data tables of a display page and display them in a way that preserves the layout of the data table while using a one-column view to display other portions of the display page.

In one embodiment, the classification system trains a classifier to classify tables as data tables or layout tables using training samples of HTML display pages. The classification system classifies the leaf tables of each display page. A leaf table is a table that contains no embedded tables. The classification system may represent the elements of a display page using the document object model (“DOM”) when identifying the tables. When the classification system identifies a leaf table, it generates a feature vector representing various features of the table. The features of the feature vector may include visual features and content features. The visual features represent the overall structure of the table, and the content features represent features of cells. Table 1 describes the visual features and content features used in one embodiment. One skilled in the art will appreciate that other features may be used to represent the table.

TABLE 1

| Type | Feature name | Description |
|---|---|---|
| Visual | Border width | The border width of the table |
| features | Row span | Number of row spans |
| | Column span | Number of column spans |
| | Row and column | Three bins representing the existence |
| | bin features | of 1-5, 6-10 and 11+ rows or columns |
| Content | Textual content | The ratio of cells with textual content to |
| features | ratio | the total number of cells |
| | Singular cell ratio | The ratio of cells spanning only one |
| | | row and one column to the total |
| | | number of cells |
| | Link content ratio | The ratio of cells containing anchor |
| | | texts to the total number of cells |
| | Image content ratio | The ratio of cells containing images to |
| | | the total number of cells |
| | Digital content ratio | The ratio of cells with digits to the total |
| | | number of cells |

The classification system also inputs the classification of the tables of the training samples. For example, the classification system may display each table to a user who indicates whether the table is a data table or a layout table. The classification system then trains a classifier using the feature vectors along with the classifications. The classification system may use any of various well-known classification techniques such as support vector machines, adaptive boosting, neural networks, and so on.

A support vector machine operates by finding a hyper-surface in the space of possible inputs. The hyper-surface attempts to split the positive examples (e.g., feature vectors for data tables) from the negative examples (e.g., feature vectors for layout tables) by maximizing the distance between the nearest of the positive and negative examples to the hyper-surface. This allows for correct classification of data that is similar to but not identical to the training data. Various techniques can be used to train a support vector machine. One technique uses a sequential minimal optimization algorithm that breaks the large quadratic programming problem down into a series of small quadratic programming problems that can be solved analytically. (See Sequential Minimal Optimization, at http://research.microsoft.com/˜jplatt/smo.html.)

Adaptive boosting is an iterative process that runs multiple tests on a collection of training data. Adaptive boosting transforms a weak learning algorithm (an algorithm that performs at a level only slightly better than chance) into a strong learning algorithm (an algorithm that displays a low error rate). The weak learning algorithm is run on different subsets of the training data. The algorithm concentrates more and more on those examples in which its predecessors tended to show mistakes. The algorithm corrects the errors made by earlier weak learners. The algorithm is adaptive because it adjusts to the error rates of its predecessors. Adaptive boosting combines rough and moderately inaccurate rules of thumb to create a high-performance algorithm. Adaptive boosting combines the results of each separately run test into a single, very accurate classifier.

A neural network model has three major components: architecture, cost function, and search algorithm. The architecture defines the functional form relating the inputs to the outputs (in terms of network topology, unit connectivity, and activation functions). The search in weight space for a set of weights that minimizes the objective function is the training process. In one embodiment, the classification system may use a radial basis function (“RBF”) network and a standard gradient descent as the search technique.

The display system uses the classifier to classify tables of a display page that is to be displayed. The display system classifies the tables of the display page by identifying the leaf tables, generating feature vectors for the identified tables, and then invoking the classifier to classify the tables based on their feature vectors. The classification of tables may be performed by a device with a small display area (e.g., a PDA) or may be performed by a server. Since devices with small display areas may have very limited computational power, the overhead of identifying tables, extracting feature vectors, and classifying the tables may be too high. A server may be used to perform the classification of the tables. The display pages may be routed to the server for classification of the tables before the display page is provided to the device. Alternatively, the device upon receiving a display page may forward it to a server which classifies the tables and returns the resulting classifications to the device.

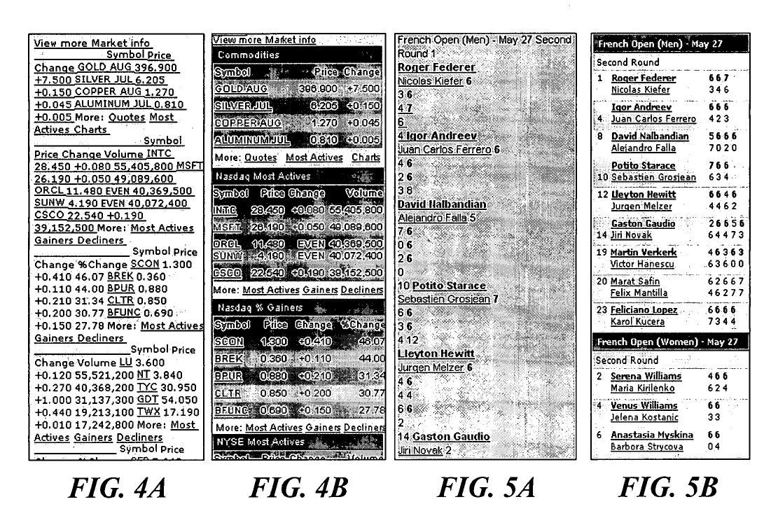

FIGS. 4A-4B and 5A-5B illustrate a one-column view and an alternate view of tables in one embodiment. FIGS. 4A and 5A illustrate that the layout of the tables in the one-column view makes it difficult to discern the meaning of the data. FIGS. 4B and 5B illustrate that the data tables are displayed in a way to preserve the meaning of the data.

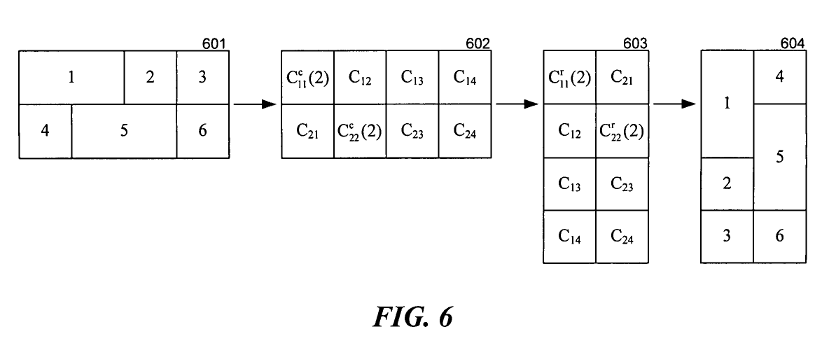

In one embodiment, when a data table is too wide to fit the display device, the display system determines whether a transposed data table would fit the display device. The transpose of an HTML table accounts for the column span (“COLSPAN”) and row span (“ROWSPAN”) properties of cells of the table. Column span defines the number of columns that a cell spans, and row span defines the number of rows that a column spans. The display system generates a mapping table that has a cell for each cell of the table if there was no spanning. The display system marks the initial cell of a span to its length. The transpose of a table can be represented by the following equation:
m×n→n×m; cᵢⱼ^{r}(k)−>cᵢⱼ^{c}(k); cᵢⱼ^{c}(k)−>cⱼᵢ^{r}(k); cᵢⱼ−>cⱼᵢ (1)
where m represents the number of rows of the table, n represents the number of columns of the table, cᵢⱼ represents the cell in the i^{th} row and the j^{th} column (1≦i≦m, 1≦j≦n), cᵢⱼ^{c}(k) represents the cell in the i^{th} row and the j^{th} column which has COLSPAN=k, k≧2, and cᵢⱼ^{r}(k) represents the cell in the i^{th} row and the j^{th} column which has ROWSPAN=k, k≧2. The display system calculates the width and height of the transposed data table to ensure that the transpose reduces the width of the original data table. FIG. 6 is a block diagram that illustrates the transpose of a data table in one embodiment. Data table 601 includes two rows and four columns and contains six cells. Cells 1 and 5 each span two columns. Mapping table 602 illustrates the label of each cell along with the column span of the original data table. Mapping table 603 illustrates the label of each cell along with the row span of the transposed data table. The display system uses Equation 1 to generate mapping table 603 from mapping table 602. The display system then generates the transposed data table 604 by copying the content of the cells identified in mapping table 603.

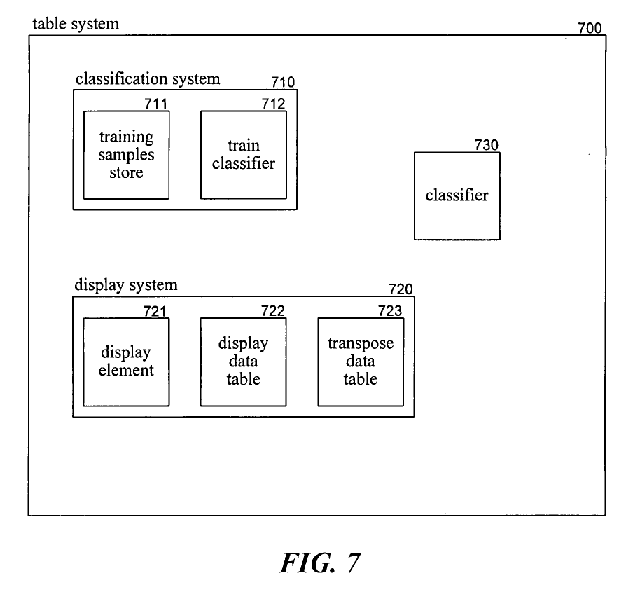

FIG. 7 is a block diagram that illustrates components of the table system in one embodiment. The table system 700 includes a classification system 710, a display system 720, and a classifier 730. The classification system includes a training sample store 711 and a train classifier component 712. The training sample store contains the display pages used to train the classifier. The training sample store may also include a classification for each leaf table of a display page as being a data table or a layout table. The train classifier component generates feature vectors for the training samples and then trains a classifier using the feature vectors along with classifications of the tables. The classification system would typically be implemented on a conventional computer system with conventional computational power, rather than on a device with limited computational power (such as a PDA). The display system includes a display element component 721, a display data table component 722, and a transpose data table component 723. The display element component is invoked to display a display page. The display element component may be recursively invoked to display each sub-element of a display page. When the display element component encounters a leaf table, it invokes the classifier to determine whether the table is a data table or not a data table. If the table is a data table, then the component invokes the display data table component. The display data table component may determine the appropriate alternate view for the data table. The display data table component may invoke the transpose data table component to transpose the data table as appropriate. Various components of the display system may be performed on a conventional computer system with conventional computational power or a device with low computational power. For example, a server computer system may identify the data tables before providing the display page to a device with a small display area that has low computational power. Indeed, the server computer system may provide the display page to the device in a form that is appropriate for display on that device with limited processing. For example, the server computer system may identify the data tables and determine the appropriate alternate view for each data table. As described above, the classifier may be any of a variety of well-known classifiers.

The computing device on which the table system is implemented may include a central processing unit, memory, input devices (e.g., keyboard and pointing devices), output devices (e.g., display devices), and storage devices (e.g., disk drives). The memory and storage devices are computer-readable media that may contain instructions that implement the table system. In addition, the data structures and message structures may be stored or transmitted via a data transmission medium, such as a signal on a communications link. Various communication links may be used, such as the Internet, a local area network, a wide area network, a point-to-point dial-up connection, or a cellphone network.

The table system may be implemented in various operating environments that include personal computers, PDAs, cell phones, server computers, hand-held or laptop devices, multiprocessor systems, microprocessor-based systems, programmable consumer electronics, network PCs, minicomputers, mainframe computers, distributed computing environments that include any of the above systems or devices, and the like.

The table system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

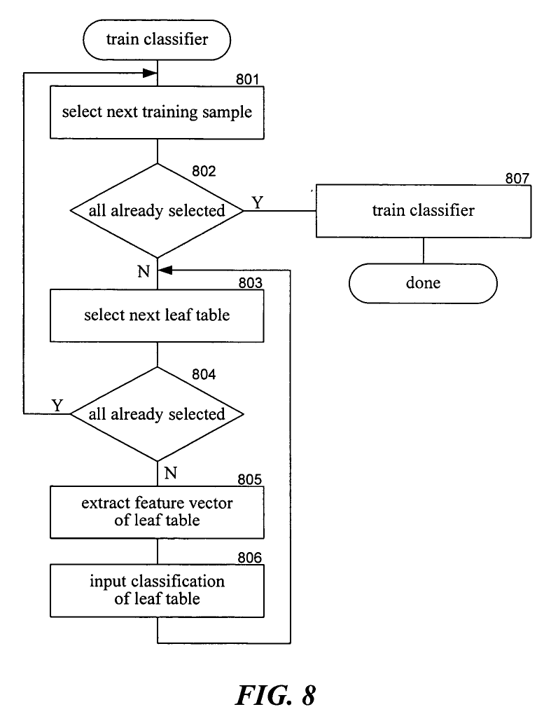

FIG. 8 is a flow diagram that illustrates the processing of the train classifier component in one embodiment. The component loops selecting each training sample, identifying leaf tables of the training samples, extracting the feature vectors of the leaf tables, and inputting a classification of the leaf tables. The component then trains the classifier. In block 801, the component selects the next training sample from the training sample store. In decision block 802, if all the training samples have already been selected, then the component continues at block 807, else the component continues at block 803. In block 803, the component selects the next leaf table of the selected training sample. The component may transform the training sample to a DOM view to identify the leaf tables. In decision block 804, if all the leaf tables of the selected training sample have already been selected, then the component loops to block 801 to select the next training sample, else the component continues at block 805. In block 805, the component extracts the feature vector of the selected leaf table. In block 806, the component inputs a classification of the leaf table. The classification may be input manually by a user. The component then loops to block 803 to select the next leaf table of the selected training sample. In block 807, the component uses the extracted feature vectors and the input classifications to train the classifier. The component then completes.

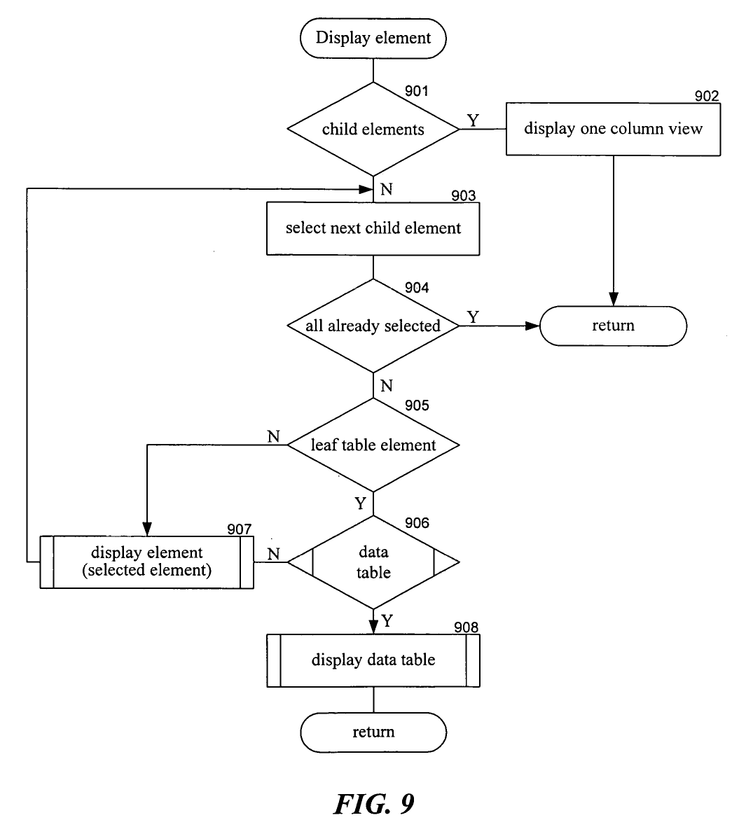

FIG. 9 is a flow diagram that illustrates the processing of the display element component in one embodiment. The display element component is a recursive component that is initially invoked passing a display page. The component is recursively invoked to process each child element of the passed element. The component invokes the classifier to determine whether a leaf table is a data table or a layout table. In decision block 901, if the passed element has no child elements, then the component continues at block 902, else the component continues at block 903. In block 902, the component displays the passed element using a one-column view and then returns. In block 903, the component selects the next child element of the passed element. In decision block 904, if all the child elements of the passed element have already been selected, then the component returns, else the component continues at block 905. In decision block 905, if the selected child element is a leaf table, then the component continues at block 906, else the component continues at block 907. In decision block 906, the component invokes the classifier to determine whether the leaf table element is a data table. If so, then the component continues at block 908, else the component continues at block 907. In block 907, the component recursively invokes the display element component passing the selected element. The component then loops to block 903 to select the next child element of the passed element. In block 908, the component invokes the display data table component to display the selected data table. The component then returns.

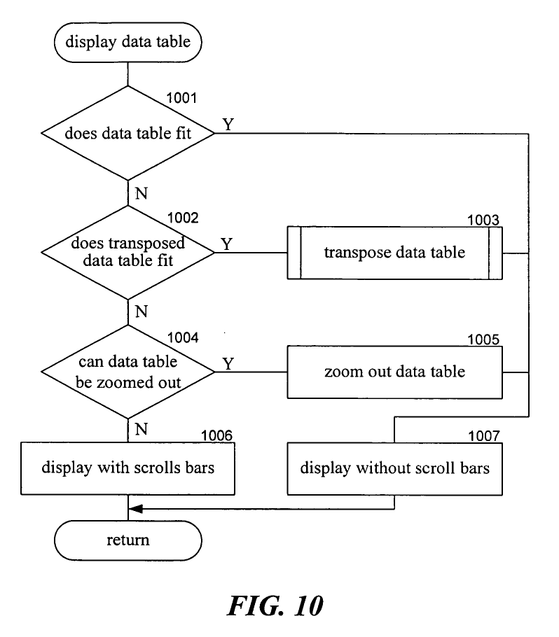

FIG. 10 is a flow diagram that illustrates the processing of the display data table component in one embodiment. The display data table component may select between various alternative views that are appropriate for displaying the passed data table. In decision block 1001, if the data table fits within the width of the display area, then the component continues at block 1007, else the component continues at block 1002. In decision block 1002, if the transposed data table would fit within the display area, then the component continues at block 1003, else the component continues at block 1004. In block 1003, the component invokes the transpose data table component to transpose the passed data table. The component then continues at block 1007. In decision block 1004, if the data table can be zoomed out to an acceptable level, then the component continues at block 1005, else the component continues at block 1006. In block 1005, the component zooms out the data table and continues at block 1007. In block 1006, the component displays the passed data table with scrollbars and then returns. In block 1007, the component displays the passed data table without scrollbars and then returns.

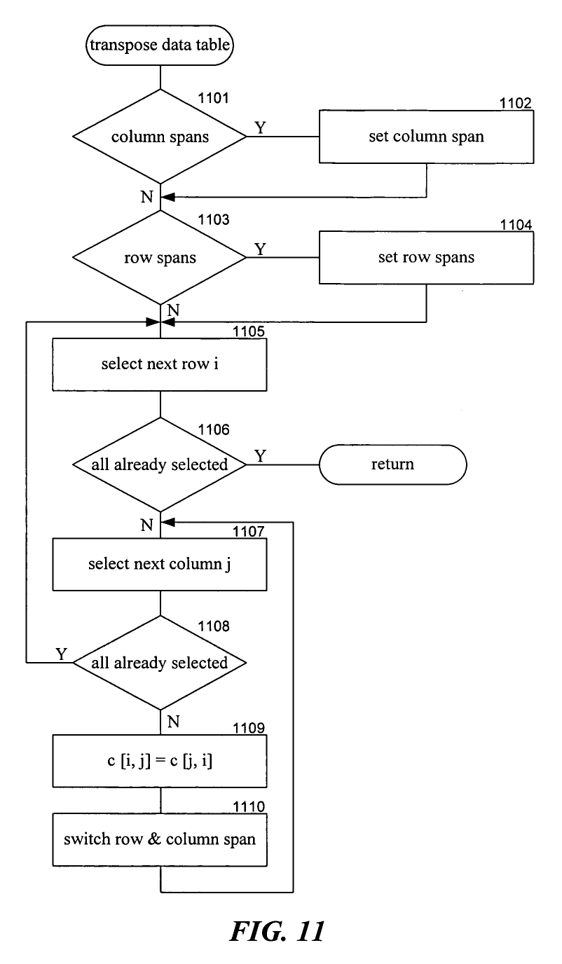

FIG. 11 is a flow diagram that illustrates the processing of the transpose data table component in one embodiment. The component is passed a data table and transposes the data table using Equation 1. In decision block 1101, if the passed data table includes column spans, then the component continues at block 1102 to set the column spans of the mapping table, else the component continues at block 1103. In decision block 1103, if the passed data table includes row spans, then the component continues at block 1104 to set the row spans of the mapping table, else the component continues at block 1105. In decision blocks 1105-1110, the component loops selecting each row and column and generating the transpose. In block 1105, the component selects the next row. In decision block 1106, if all the rows have already been selected, then the component returns, else the component continues at block 1107. In block 1107, the component selects the next column for the selected row. In decision block 1108, if all the columns for the selected row have already been selected, then the component loops to block 1105 to select the next row, else the component continues at block 1109. In block 1109, the component transposes the cells of the selected row and column. In block 1110, the component switches a row span to a column span and a column span to a row span as appropriate. The component then loops to block 1107 to select the next column for the selected row.

One skilled in the art will appreciate that although specific embodiments of the table system have been described herein for purposes of illustration, various modifications may be made without deviating from the spirit and scope of the invention. Accordingly, the invention is not limited except as by the appended claims.

I/We claim:

1. A method for displaying a data table, the method comprising:
providing a table classifier that classifies a table as a data table or not a data table based on features of the table;
providing a display page having one or more tables; and
for a table of the provided display page,
identifying features of the table;
classifying the table as being a data table or not a data table by applying the table classifier to the identified features; and
displaying the table based on whether the table is classified as a data table or not a data table.

2. The method of claim 1 including training the table classifier using training samples of tables, the training including generating feature vectors for the training samples and receiving classifications of the training samples.

3. The method of claim 2 wherein the table classifier is implemented using a support vector machine.

4. The method of claim 3 wherein the table classifier is implemented using a neural network.

5. The method of claim 1 wherein the displaying includes using a one-column view for a table classified as not a data table and an alternate view for a table classified as a data table.

6. The method of claim 5 wherein the alternate view is from the group consisting of a scrolling view, a zoomed view, and a transposed view.

7. The method of claim 1 wherein the features include visual features and content features.

8. The method of claim 7 wherein a visual feature is from the group consisting of border width, row span, column span, and row and column bins.

9. The method of claim 7 wherein a content feature is from the group consisting of textual content ratio, singular cell ratio, link content ratio, image content ratio, and digital content ratio.

10. A computer-readable medium containing instructions for controlling a computer system to classify a data table, by a method comprising:
providing a table classifier that classifies a table as a data table or not a data table based on features of the table;
providing a display page having one or more tables; and
classifying a table of the display page as being a data table or not a data table by applying the table classifier to features of the table.

11. The computer-readable medium of claim 10 wherein the classifying is performed by a server that provides the classification to a device for display of the table based on the classification.

12. The computer-readable medium of claim 10 wherein the classifying is performed by a device that displays the table in accordance with the classification.

13. The computer-readable medium of claim 10 including training the table classifier using training samples of tables, the training including identifying features of the training samples and receiving classifications of the training samples.

14. The computer-readable medium of claim 10 including when the table is classified as a data table, displaying the table in a view from the group consisting of a scrolling view, a zoomed view, and a transposed view.

15. The computer-readable medium of claim 10 wherein the features include visual features and content features.

16. A system for classifying a data table, by a method comprising:
a table classifier that classifies a table as a data table or not a data table based on a feature of the table; and
a component that classifies a table as being a data table or not a data table by applying the table classifier to a feature of the table.

17. The system of claim 16 wherein the component that classifies is a component of a server that provides the classification to a device for display of the table based on the classification.

18. The system of claim 16 wherein the component that classifies is a component of a device that displays the table in accordance with the classification.

19. The system of claim 16 wherein the table, is a table of a display page.

20. The system of claim 16 including a component that trains the table classifier using training samples of tables, the training including identifying features of the training samples and receiving classifications of the training samples.
